(19) United States
(12) Patent Application Publication
(10) Pub. No.: US 2009/0172563 A1
(43) Pub. Date: Jul. 2, 2009

(54) METHOD AND APPARATUS FOR USING USER CREATED CONTENT AS USER INTERFACE

(75) Inventors: Ju-Hyeon YUN, Anyang-si (KR); Sang-Jun Ahn, Seoul (KR)

Correspondence Address: THE FARRELL LAW FIRM, P.C., 290 Broadhollow Road, Suite 210E, Melville, NY, 11747, US

(73) Assignee: SAMSUNG ELECTRONICS CO., LTD., Suwon-si (KR)

(21) Appl. No.: 12/341,566

(22) Filed: Dec. 22, 2008

(30) Foreign Application Priority Data
Dec. 21, 2007 (KR) 10-2007-0135371

(51) Int. Cl. G06F 3/01

(52) U.S. Cl. 715/747

(57) ABSTRACT

A method and an apparatus for using user created content stored in a Subscriber Identity Module (SIM) card as a user interface is provided. According to the method and apparatus, the SIM card stores the user created content, and a terminal platform executes and displays the user created content if any one of the user created content stored in the SIM card is selected. A Java platform receives the selected user created content from the SIM card, and transmits the received user created content to the terminal platform.

### PRIORITY

This application claims priority under 35 U.S.C. §119(a) to an application entitled “Method and Apparatus for Using User Created Content as User Interface,” filed in the Korean Intellectual Property Office on Dec. 21, 2007, and assigned Serial No. 2007-135371, the contents of which are incorporated herein by reference

### BACKGROUND OF THE INVENTION

1. Field of the Invention

The present invention relates to a method and an apparatus for using user created content as a user interface, and more particularly, to a method and an apparatus for using User Created Content (UCC) stored in a Subscriber Identity Module (SIM) card as a user interface.

2. Description of the Related Art

A user interface used in a conventional terminal executes applications through several fixed methods or operations. However, this is not able to sufficiently satisfy users who desire more developed functions of a portable terminal. Accordingly, a new function has been adopted in terminals, which constructs a display screen with a screen design selected by a user.

The screen construction function described above enables a user to select a desired screen design from among screen designs that are stored in the terminal and to apply the selected screen design to the screen of the terminal. Designs corresponding to items for setting the screen, such as a normal screen, a background screen, a menu design, a dial design, and the like, are selected to construct the screen accordingly. A normal screen is an initial screen, or a terminal standby screen, and a normal screen design may be set by selecting an image that was downloaded or is stored in the terminal. The background screen, the menu design, and the dial design may be set according to user selections of a frame type pre-stored in the terminal, a frame color, and images of elements constituting the frame. The screen is then constructed with the selected frame type, frame color, and images of the elements.

According to the above-described screen construction function, the screen is constructed by selecting a downloaded or stored image as a normal screen, or selecting one of a plurality of screen design formats pre-stored in the terminal. Thus, it is impossible for a user to directly create the screen design. Accordingly, there has been an increasing demand for a user to directly construct diverse screen designs instead of selecting a pre-stored screen design format.

A Subscriber Identity Module (SIM) card is a card type module that can be used in a mobile communication terminal. The SIM card is in the form of a chip which stores personal information so as to provide diverse services, such as subscriber's authentication, billing, security function, and the like. The SIM card enables a user to freely perform mobile communication with his/her own phone number in any place, irrespective of the mobile communication technology standards, such as Code Division Multiple Access (CDMA), Global System for Mobile telecommunication (GSM), and the like. A SIM for Universal Mobile Telecommunication System (UMTS), which is the third generation mobile communication system, may be called a Universal Subscriber Identity Module (USIM).

Even though a user's terminal is changed, data stored in the SIM card that is installed in the terminal can be continuously used. By mounting the SIM card in a new terminal, a user can use the functions available in the existing terminal as they are. Accordingly, there is a need for a method and apparatus that enables a user to use a SIM card, in which a menu design and a dial design created by the user are stored, irrespective of the change of a user's terminal.

### SUMMARY OF THE INVENTION

The present invention has been made to address at least the above problems and/or disadvantages and to provide at least the advantages described below. Accordingly, an aspect of the present invention provides a method and an apparatus for using user created content stored in a SIM card as a user interface.

According to one aspect of the present invention, an apparatus for using user created content as a user interface is provided. The apparatus includes a SIM card for storing, in accordance with resolution standards of a terminal, at least one user created content and content resolution information that indicates an area where the user created content is executed and displayed through the terminal, and when a transmission request for any one of the stored user created content is received, transmitting the requested user created content and the content resolution information in accordance with resolution of the corresponding terminal. The apparatus also includes the terminal for receiving the selected user created content and the content resolution information when any one of the user created content stored in the SIM card is selected, converting resolution of the user created content into resolution of the terminal using the content resolution information, and executing the converted user created content.

According to another aspect of the present invention, a method for storing user created content through a SIM card is provided. At least one user created content is received from a terminal in which the SIM card is installed, and stored. Resolution information of the stored user created content is read. Content resolution information is generated, in accordance with resolution standards of the terminal, using the read resolution information, and the generated content resolution information, corresponding to the user created content, is stored.

According to an additional aspect of the present invention, a method is provided for using user created content as a user interface through a SIM card externally connected to a terminal. A request for any one of at least one pre-stored user created content is received from a terminal. It is determined whether display size information of the terminal coincides with resolution information of the requested user created content. When the display size information does not coincide with the resolution information, it is determined whether content resolution information that coincides with the display size information exists among content resolution information, in accordance with resolution standards of the terminal, stored corresponding to the user created content. When the content resolution information that coincides with the display size information exists, the corresponding content resolution information is set as the resolution information of the user created content. The user created content and the set resolution information are transmitted to the terminal.

According to a further aspect of the present invention, a method is provided for using user created content as a user interface through a terminal to which a SIM card is externally connected. User created content is requested from the SIM card installed in the terminal. The requested user created content and resolution information corresponding to the user created content are received from the SIM card, and the received user created content and the resolution information are copied and stored. The user created content is reconstructed by converting the size of the user created content into a size corresponding to resolution of the terminal, and the reconstructed user created content is executed.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a flowchart illustrating a method for storing user created content through a terminal according to an embodiment of the present invention;

FIGS. 2A and 2B are data tables showing elements constituting user created content and execution values corresponding to the elements according to an embodiment of the present invention;

FIG. 3 is a diagram illustrating reception of user created content through a SIM card installed in a terminal according to an embodiment of the present invention;

FIG. 4 is a block diagram schematically illustrating the configuration of a terminal and a SIM card according to an embodiment of the present invention;

FIG. 5 is a flowchart illustrating a method for executing user created content through a terminal according to an embodiment of the present invention;

FIG. 6 is a flowchart illustrating a method for executing user created content through a user interface using a SIM card installed in a terminal according to an embodiment of the present invention;

FIGS. 7A to 7C are diagrams illustrating a data structure of a SIM card according to an embodiment of the present invention; and

FIG. 8 is a diagram illustrating a resolution table in which content resolution information is stored by display standards according to an embodiment of the present invention.

### DETAILED DESCRIPTION OF THE PREFERRED EMBODIMENTS

Preferred embodiments of the present invention are described in detail with reference to the accompanying drawings. In the following description of the present invention, the same or similar drawing reference numerals are used for the same elements even in different drawings. Additionally, detailed descriptions of constructions or processes known in the art may be omitted to avoid obscuring the subject matter of the present invention.

In an embodiment of the present invention, information regarding resolution of a terminal is called “display size information.” Information regarding resolution that user created content has in order for the content to be displayed on a display unit when the content is executed through a terminal is called “resolution information.” Also, information regarding resolution information of the user created content stored, by standards of a terminal, corresponding to the user created content so that the resolution information of the user created content can be applied to all terminals is called “content resolution information.” The content resolution information indicates a value which can be recognized instead of the actual resolution of user created content when it is intended to execute, through a terminal, the user created content having resolution that does not coincide with the resolution of the terminal.

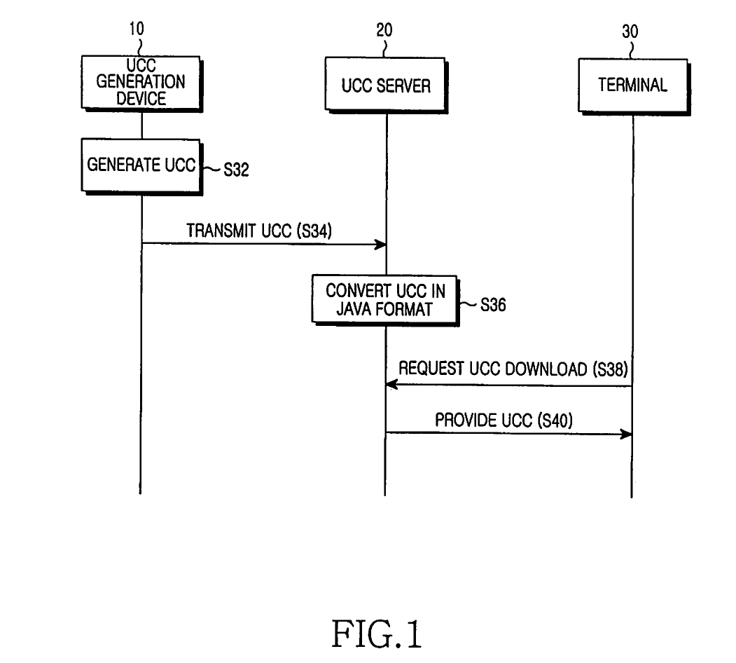

FIG. 1 is a flowchart illustrating a method for storing user created content through a terminal according to an embodiment of the present invention.

The User Created Content (UCC) generation device 10 is a tool for storing a program for creating UCC, which has elements for screen design and menu execution information, and can give specified execution information to the respective elements. A UCC server 20 stores UCC transmitted from a plurality of UCC generation devices 10, together with specified identifiers for discriminating among the plurality of UCC.

Referring to FIG. 1, if UCC is generated by a user in step S32, the UCC generation device 10 uploads the generated UCC to the UCC server 20 in step S34. The UCC generation device 10 may transmit the generated UCC to the UCC server 20 through the Internet.

If the UCC generated by the user is received from the UCC generation device 10, the UCC server 20 converts the UCC into a Java format and stores the converted UCC in step S36. The UCC server 20 can generate a data table in which elements included in the UCC are mapped on specified menu execution information of a terminal 30. Also, the UCC server 20 can convert the UCC including the generated data table in a specified application format, and store the converted UCC. The UCC is provided to the terminal 30 in the form of a MIDlet, and the terminal 30 stores the UCC in the form of a MIDlet. The UCC in the form of a MIDlet includes JAR files and JAD files. The JAR file has UCC information for constructing a User Interface (UI) in the terminal 30, and the UCC information is generated in a data table structure.

If the terminal 30 requests a UCC download from the UCC server 20 in step S38, the UCC server provides UCC in a Java format to the terminal 30 in step S40.

In an embodiment of the present invention, the terminal 30, when requesting the UCC download from the UCC server, may include a specified identifier to identify the UCC, which the user desires to download, in a request message to be transmitted to the UCC server 20. Accordingly, the terminal 30 can download the UCC desired by the user. The UCC server 20 can provide the UCC corresponding to the UCC identifier to the terminal 30 through recognition of the UCC identifier included in the request message.

The terminal 30, which has received the UCC, adopts the UCC transmitted from the UCC server 20 as a user interface of the terminal 30, and executes a corresponding menu in accordance with the menu execution information set in a specified element included in the user interface when the element is selected.

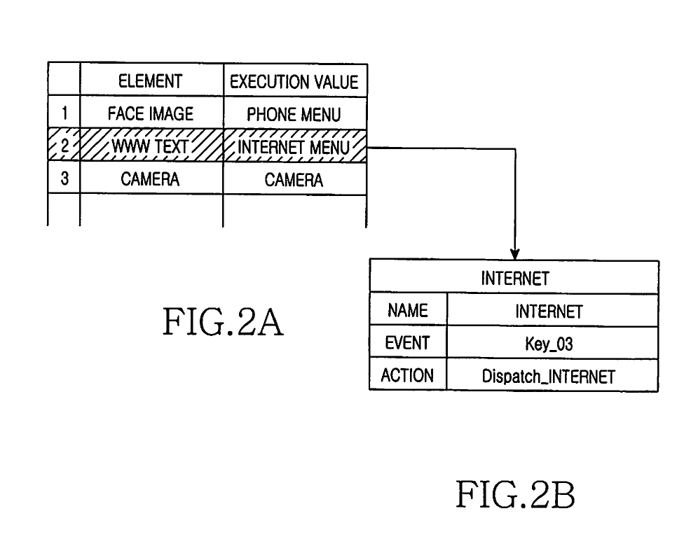

FIGS. 2A and 2B are data tables showing elements constituting user created content and execution values corresponding to the elements, according to an embodiment of the present invention.

Referring to FIG. 2A, a plurality of graphic elements constituting the UCC and execution values including information for controlling execution of specified menus of the terminal 30 for the respective elements are stored as shown in the data table.

Also, for each element, corresponding menu execution information as shown in FIG. 2B is stored. An application name is presented as a name item, and event information for detecting selection of a corresponding element is presented as an event item. The event information may include, for example, a key input for selecting the corresponding element. Also, information on a factor, which is transferred to a dispatch function to be called for actual execution of the application, is presented as an action item.

For example, for a “face image” element, an execution value indicating “phone menu” may be set, and if a phone rings, a telephone element may be set to move in a predetermined motion. The motion information predetermined in the telephone element may be presented as the action item as shown in FIG. 2B. Also, for a “www text” element, an execution value indicating an “Internet menu” is presented.

Referring to FIG. 2B illustrating the detailed menu execution information of the “www text,” the name of an application that is executed corresponding to the “www text” element is “Internet,” and if “key_{—}03” is inputted, the “www text” element is selected. Also, if the element is selected through the input of “key_{—}03,” the terminal 30 calls “Dispatch_INTERNET” as a dispatch function in order to execute the Internet application.

In the same manner, in a “camera” element, an execution value for executing a camera menu is set.

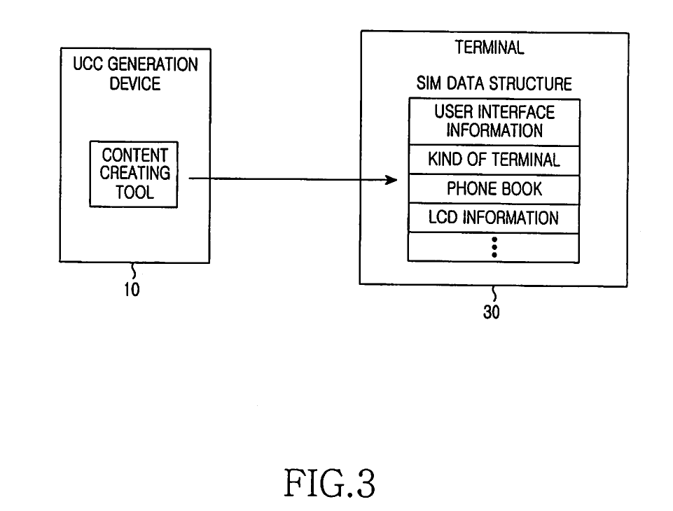

FIG. 3 is a diagram illustrating reception of user created content through a SIM card installed in a terminal according to an embodiment of the present invention.

In the embodiment of the present invention, it is assumed that the UCC generation device 10 and the UCC server 20 are implemented in a single body.

The UCC generation device 10 transmits UCC generated by the terminal 30 in which the SIM card is installed. The SIM card can store the UCC in accordance with a predetermined SIM data structure. The SIM card may include a data structure, such as user interface information, a terminal type, a phone book, LCD information, and the like.

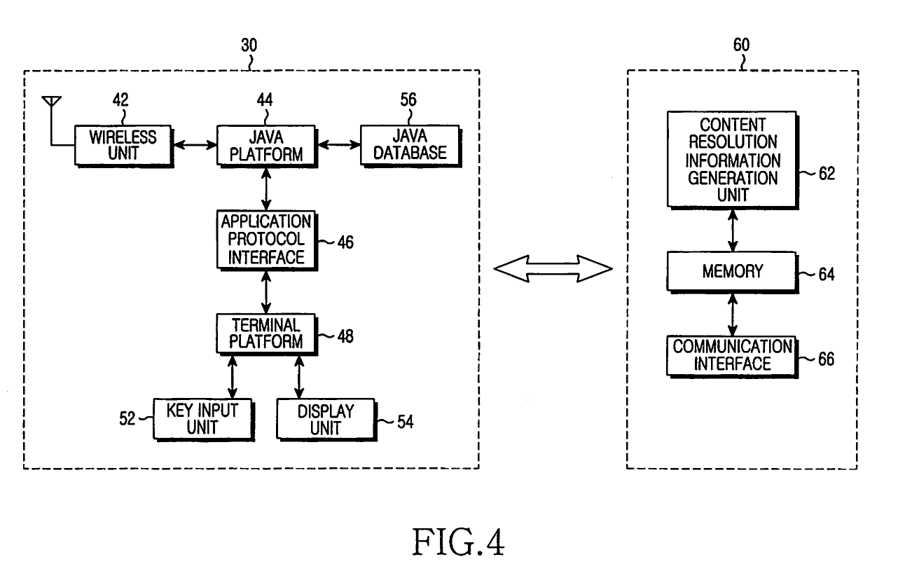

FIG. 4 is a block diagram schematically illustrating the configuration of a terminal and a SIM card according to an embodiment of the present invention.

The terminal 30 includes a wireless unit 42, a Java platform 44, an application protocol interface 46, a terminal platform 48, a key input unit 52, a display unit 54, and a Java database 56. The wireless unit 42 receives the UCC from the UCC server 20. The Java platform 44 stores the UCC received through the wireless unit 42 in the Java database 56.

The application protocol interface 46 transfers a plurality of elements that correspond to user interface information included in the UCC and information for controlling execution of a specified menu of the terminal 30 for each element, which are outputted from the Java platform 44, to the terminal platform 48. Java Native Interface (JNI) may be used as the application protocol interface 46. JNI is an application protocol interface provided to access a native code, that is, a C language environment, of the terminal in a Java program. Through the JNI, objects, variables, and functions can be called between the Java and the native code.

The terminal platform 48 controls the entire terminal 30. In order to construct the UCC as the user interface of the terminal 30, the terminal platform 48 receives UCC information through the application protocol interface 46, and constructs the UCC.

The key input unit 52 is provided with a plurality of numeral keys and function keys, and outputs input data corresponding to a key selected by a user to the terminal platform 48. The key input unit 52 may be a general key matrix or a touch screen. In the case where the key input unit 52 is implemented by a touch screen, numeral keys, function keys, and direction keys that are displayed on the touch screen can be selected or inputted using an input tool, such as a stylus pen.

The display unit 54, under the control of the terminal platform 48, receives and displays display data for key input data inputted from the key input unit 52, or displays the operation state of the terminal 30 and a plurality of information with icons and characters. Also, the display unit 54, under the control of the terminal platform 48, displays a function state as the user sets or drives a necessary function. The display unit 54 may be implemented by a Liquid Crystal Display (LCD), Thin Film Transistor (TFT), an organic electroluminescence, and the like.

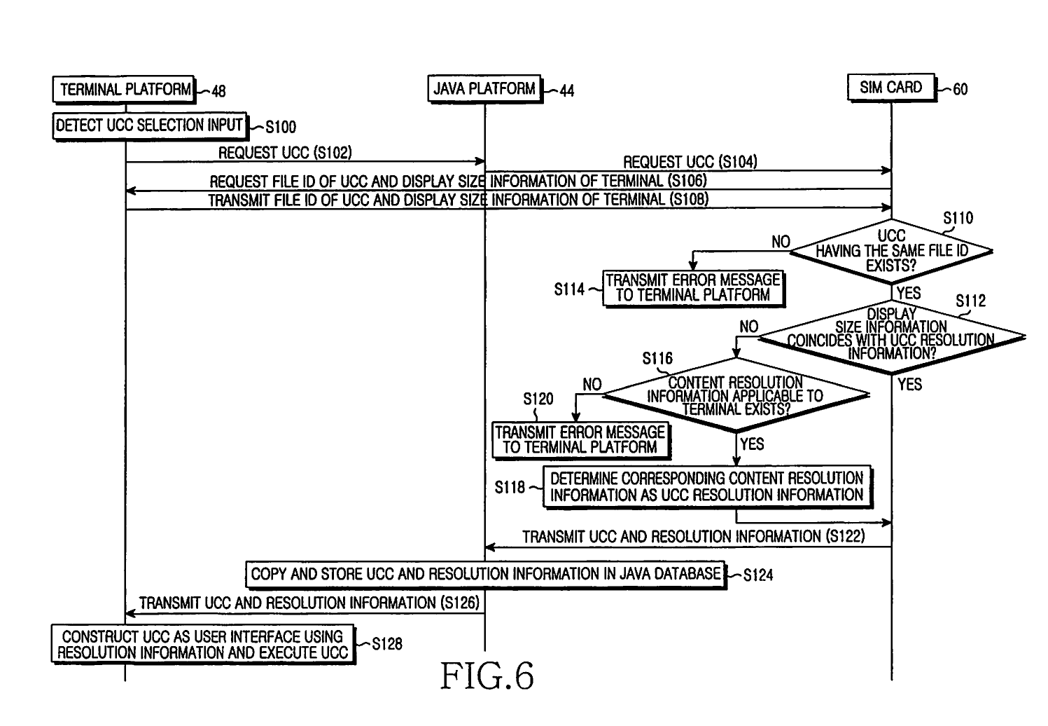

The operation of the terminal 30 may be classified into an initialization operation for applying and executing the UCC as the user interface of the terminal 30 and a menu execution operation corresponding to the selected element. The operation of the terminal 30 will be described greater detail below with reference to FIG. 6.

The SIM card 60 includes a content resolution information generation unit 62, a memory 64, and a communication interface 66.

The content resolution information generation unit 62 generates content resolution information. The content resolution information is information for applying a display size of the UCC to a display size of the terminal so that the UCC can be displayed on the display unit 54 of the terminal 30. If the content resolution information coincides with the resolution standard of the terminal, even though the corresponding UCC has a display size that cannot be actually executed, the corresponding terminal 30 can recognize the resolution, and execute the UCC.

The content resolution information generation unit 62 generates the content resolution information with reference to the resolution information of the transmitted UCC, if the specified UCC is transmitted to the SIM card 60.

The content resolution information generation unit 62 generates the content resolution information in accordance with the display size, i.e. the resolution of the terminal 30, so that the UCC can be displayed, even through the terminal 30 has a resolution that differs from the designated resolution when the UCC is generated by the UCC generation device 10.

For example, if the resolution of the UCC stored in the SIM card is a Quarter Video Graphics Array (QVGA) (320 by 240 pixels; 1.33:1 aspect ratio), the content resolution information generation unit 62 generates the content resolution information of Quarter Common Intermediate Format (QCIF) (176 pixels by 144 lines, 30 fps; 1.22:1) and Video Graphics Array (VGA) (640 by 480 pixels; 1.33:1 aspect ratio). If the display resolution of the terminal 30 is QCIF, the SIM card 60 stores the content resolution information of QCIF in the terminal 30 together with the UCC. The terminal 30 converts the size of the UCC using the content resolution information of QCIF, and displays the UCC with the converted size. Accordingly, the terminal 30 can execute the UCC irrespective of the actual resolution of the UCC.

Preferably, the content resolution information generation unit 62 may store the generated content resolution information in the form of a table, corresponding to the UCC.

The memory 64 stores the UCC and the content resolution information generated for each UCC.

The communication interface 66 controls communications with the terminal 30. The SIM card 60 can receive the UCC from the terminal 30 through the communication interface 66. The UCC transmitted to the SIM card 60 may be the UCC temporarily stored in the terminal 30. Also, the communication interface 66 receives display size information from the terminal 30, and transmits the UCC and the UCC resolution information or content resolution information stored in accordance with resolution standards of the terminal.

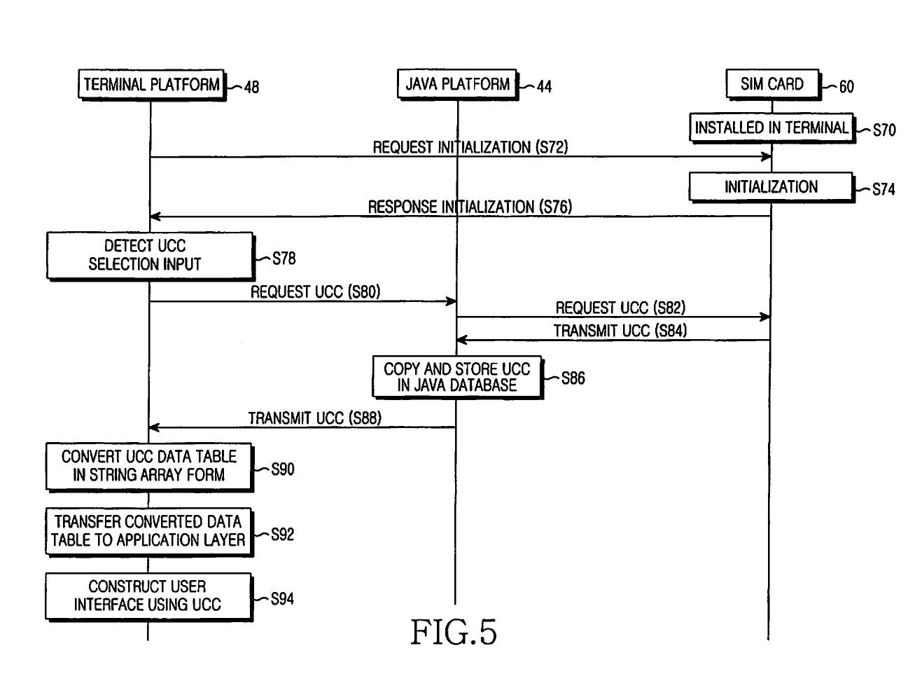

FIG. 5 is a flowchart illustrating a method for executing user created content through a terminal according to an embodiment of the present invention.

Although the application protocol interface 46 is not illustrated in the drawing, it is assumed that the application protocol interface 46 exists between the terminal platform 48 and the Java platform 44, and relays data communication between the two platforms. That is, data transmitted from the terminal platform 48 to the Java platform 44 is converted into a data form suitable for the Java platform 44 through the application protocol interface 46, and data transmitted from the Java platform 44 to the terminal platform 48 is converted into a data form suitable for the terminal platform 48 through the application protocol interface 46.

If the SIM card 60 is installed in the terminal 30 in step S70, the terminal platform 48 requests initialization from the SIM card 60. The SIM card 60 performs the initialization in step S74, and transmits an initialization response to the terminal platform 48 in step S76. The initialization response that the SIM card 60 transmits to the terminal platform 48 may include an Answer To Reset (ATR). ATR has a length corresponding to 33 characters at maximum, and includes a data transfer rate and a programming voltage value. By transmitting the above-described information to the terminal platform 48, the SIM card 60 transfers information required to drive the SIM card.

If the terminal platform 48 detects a UCC selection input through the key input unit 52 in step S78, it requests the UCC from the Java platform 44 in step S80. If the UCC is pre-stored in the Java database 56, the Java platform 44 can transmit the UCC stored in the Java database 56 to the terminal platform 48. However, if the selected UCC is not pre-stored in the Java database 56, but is stored in the SIM card 60, the Java platform 44 requests and receives the UCC from the SIM card 60.

The Java platform 44 requests the UCC from the SIM card in step S82. The SIM card 60 transmits the requested UCC to the Java platform 44 in step S84. The Java platform 44 copies and stores the transmitted UCC in the Java database 56 in step S86.

The Java platform 44 transmits the stored UCC to the terminal platform 48 in step S88. The terminal platform 48 converts the data table of the UCC in the form of a string array in step S90. Also, the terminal platform 48 transfers the converted data table to an application layer in step S92, and constructs a user interface using the UCC in step S94.

The converted data table indicates a table in which execution values, such as elements of the UCC, names of respective elements, events, actions, and so forth, are set. The terminal platform 48 displays the user interface constructed in step S94 through the display unit 54.

FIG. 6 is a flowchart illustrating a method for executing user created content through a user interface using a SIM card installed in a terminal according to an embodiment of the present invention.

The terminal platform 48 detects an input for selecting UCC through the key input unit 52 in step S100. The terminal platform 48 requests the selected UCC from the Java platform 44 in step S102, and the Java platform 44 requests the UCC, of which the selection input is detected by the terminal platform 48 in step S102, from the SIM card 60 in step S104.

The SIM card 60 requests a file ID of the UCC and display size information of the terminal 30 from the terminal platform 48 in step S106. The terminal platform 48 transmits the file ID and the display size information to the SIM card 60 in step S108.

The file ID indicates the file ID of the UCC, and the display size information of the terminal 30 indicates an actual size of the display unit 54 in the terminal 30.

In another embodiment of the present invention, the terminal platform 48 can transmit the file ID and the display size information to the SIM card 60, even if a request for the file ID and the display size information is not received from the SIM card 60. For example, if an input for using the UCC stored in the SIM card 60 is detected through the terminal platform 48 as soon as the SIM card 60 is installed in the terminal 30, the terminal platform 48 immediately requests the UCC by transmitting the file ID of the corresponding UCC and the display size information to the SIM card 60.

The SIM card 60 determines whether the UCC having the same file ID as the file ID received from the terminal platform 48 exists in step S110. If the UCC having the same file ID as the received file ID does not exist (“No” in step S110), it means that the UCC requested through the terminal platform 48 does not exist in the SIM card 60. Accordingly, the SIM card 60 transmits an error message to the terminal platform 48 in step S114. The terminal platform 44, having received the error message, controls the display unit 54 to display a notice “The selected UCC does not exist,” through, for example, a popup.

If the UCC having the same file ID exists (“Yes” in step S110), it means that the requested UCC is stored in the SIM card 60. The SIM card 60 determines whether the received display size information coincides with the resolution information of the stored UCC in step S112. If they do not coincide with each other (“No’ in step S112), the SIM card determines whether applicable content resolution information exists in the terminal 30 in step S116.

If the UCC from the UCC generation device 10 is received in the SIM card 60, the content resolution information generation unit 62 reads the resolution information of the received UCC, and generates content resolution information by standards of the terminal 30. For example, it is assumed that the resolution of the UCC corresponds to 240 (in width)×320 (in length) pixels. The content resolution information generation unit 62 detects that the resolution of the UCC is 240×320 pixels. Then, the content resolution information generation unit 62 stores values of 480×640 pixels, 200×300 pixels, 300×400 pixels, and the like, of the terminal 30, corresponding to the UCC as the content resolution information of the UCC.

If any one of the content resolution information stored corresponding to the UCC coincides with the display size of the terminal 30, even though the resolution of the UCC does not coincide with the display size of the terminal 30, i.e. the resolution of the terminal 30, the UCC can be applied to the terminal 30. For example, if it is assumed that the display resolution of the terminal 30 corresponds to 480×640 pixels and the resolution information of the UCC corresponds to 240×320 pixels, the SIM card 60 transmits the UCC and 480×640 pixels among the content resolution information stored for the UCC to the terminal 30 as the resolution information of the UCC. Accordingly, the terminal 30 can execute the UCC having the resolution corresponding to 240×320 pixels through application of the resolution corresponding to 480×640 pixels to the UCC. In an embodiment of the present invention, the SIM card 60 can generate the content resolution information as the resolution of the UCC is kept corresponding to the aspect ratio of the display size.

If the content size information that is compatible with the display size information exists (“Yes” in step S116), the SIM card 60 sets the corresponding content resolution information as the resolution information of the UCC in step S118. If the content resolution information does not exist (“No” in step S116), the SIM card 60 transmits an error message to the terminal platform 44 in step S120. The transmitted message may be different from that transmitted in step S114. The terminal platform 44 receives the error message from the SIM card 60, and displays a notice “The UCC cannot be executed” on the display unit 54 through a popup and so on.

The SIM card 60 transmits the UCC and the resolution information to the Java platform 44 in step S122. The Java platform 44 copies and stores the UCC and the resolution information in the Java database 56 in step S124. The Java platform 44 transmits the UCC and the resolution information to the terminal platform 48 in step S126.

The terminal platform 48 constructs the UCC as the user interface using the resolution information, and executes the constructed UCC in step S128. The terminal platform 48 constructs the UCC so that the UCC is displayed to suit the actual resolution of the display unit 54 of the terminal 30 using the resolution information. The terminal 30 recognizes the resolution information received from the SIM card 60, and reconstructs and executes the UCC with the recognized resolution.

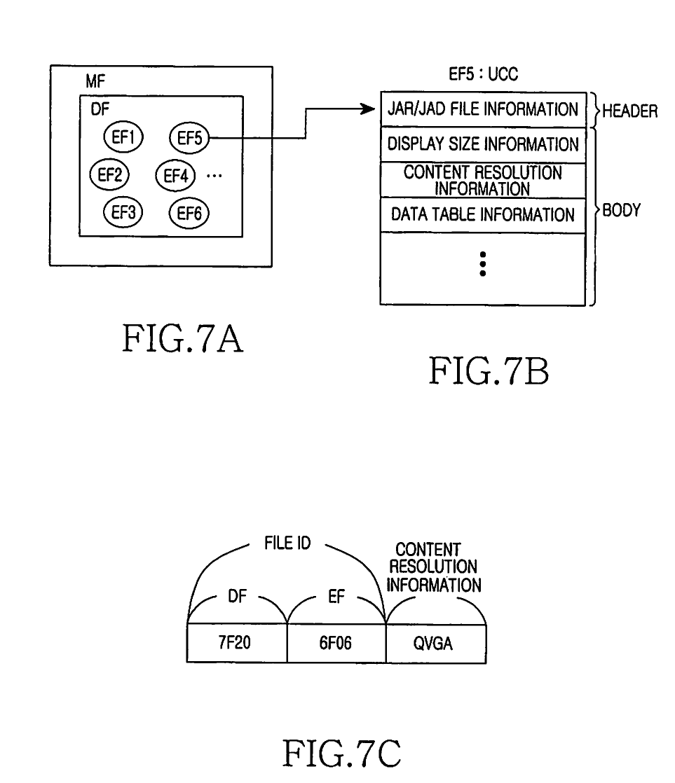

FIGS. 7A to 7C are diagrams illustrating a data structure of a SIM card according to an embodiment of the present invention.

The SIM card 60 is constructed in a manner that a Dedicated File (DF) exists under a Main File (MF), and Elementary Files (EF) exist under the DF. The MF serves as a root directory, and is the uppermost file in the SIM card 60. The DF means a directory that ties DFs or EFs, and is referred to by a file ID.

Referring to FIG. 7A, DF is included in MF, and EF1, EF2, EF3, EF4, EF5, and EF6 are included in DF. Also, referring to FIG. 7B, EF5 is the UCC, and is divided into a header and a body. JAR/JAD file information is stored in the header, and display size information, content resolution information, data table information, and the like, are stored in the body.

FIG. 7C is a view illustrating an example of the content resolution information. Referring to FIG. 7C, DF of the content resolution information is “7F20”, and EF is “6F06.” A value that DF or EF has may be an inherent value determined by the file ID of the SIM card 60. In FIG. 7C, the value of the content resolution information is “QVGA”, which is the content size information that may be used in the case where the terminal 30 having the display size of QVGA adopts the UCC.

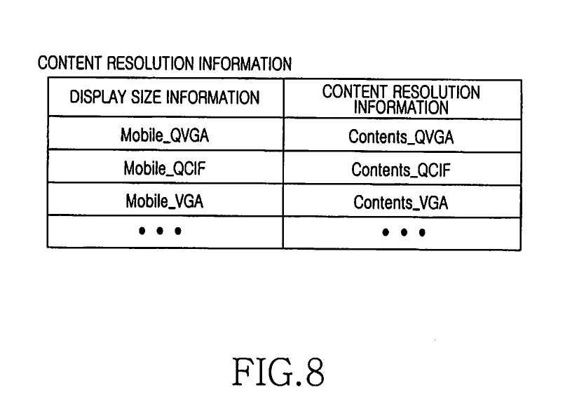

FIG. 8 is a resolution table in which content resolution information is stored by display standards according to an embodiment of the present invention.

In the embodiment of the present invention, it is assumed that the resolution table is related to UCC 2. Referring to FIG. 8, if the display size information of the terminal 30 is Mobile_QVGA, the content resolution information becomes Contents QVGA. The content resolution information is resolution information that makes it possible to apply the UCC 2 to the terminal 30 having an actual display size of Mobile_QVGA. In the same manner, Contents_QCIF is stored to correspond to Mobile_QCIF, and Mobile_VGA is stored to correspond to Contents_VGA.

According to an embodiment of the present invention, the UCC stored in the SIM card can be used as a user interface.

According to an embodiment of the present invention, by storing the UCC in the SIM card, and not in the terminal, a memory shortage phenomenon can be prevented.

According to an embodiment of the present invention, even if the terminal is changed, the UCC stored in the SIM card can be used through installation of the SIM card in the changed terminal, and thus the UCC desired by the user can be adopted as the user interface of the terminal without separately downloading the UCC.

According to an embodiment of the present invention, since the UCC can be modified to suit the display size of the terminal, it is not required for the user to create the UCC in consideration of the resolution of other terminals having different display sizes by standards.

According to an embodiment of the present invention, since the UCC can be modified to suit the display size of the terminal, the UCC can be executed and used as the user interface even if the display size is changed due to the change of the user's terminal.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A terminal for using user created content as a user interface, comprising:
a memory for storing at least one user created content and comparing a resolution information of the stored user created content with a display size information according to a resolution of the terminal's display, the display including at least one resolution modes which a number of color image pixels arranged in vertical and horizontal directions on the display when a transmission request for any of the at least one stored user created content is received, selecting one of the at least one resolution modes that can be displayed on the display as a content resolution information according to result of the comparing, and transmitting the requested user created content and the content resolution information;
a Java platform for receiving the requested user created content and the content resolution information, and transmitting the user created content and the content resolution information; and
a terminal platform for receiving the user created content and the content resolution information transmitted from the Java platform, and converting the resolution of the user created content using the received content resolution information.

2. The terminal as claimed in claim 1, wherein the memory is an SIM card which is externally connected to the terminal, the SIM card is installed in the terminal.

3. The terminal as claimed in claim 1, wherein the terminal comprises:
a Java platform for, when any of the at least one user created content is selected, requesting the selected user created content from the memory, and when the selected user created content and the content resolution information are received from the memory, storing the received user created content and the content resolution information, and transmitting the stored user created content and the content resolution information; and
a terminal platform for receiving the user created content and the content resolution information transmitted from the Java platform, and converting the resolution of the user
a terminal platform for receiving the user created content and the content resolution information transmitted from the Java platform, and converting the resolution of the user created content into the resolution of the terminal's display, and displaying the user created content with the converted resolution.

4. The terminal as claimed in claim 1, wherein the memory comprises:
a buffer for storing the at least one user created content; and
a content resolution information generation unit for generating the content resolution information in accordance with resolution standards of the terminal using the resolution information of the at least one user created content, storing the generated content resolution information corresponding to the user created content, and when the resolution information of the requested user created content does not coincide with display size information according to the resolution of the terminal, selecting one of the at least one resolution modes that can be displayed on the display as a content resolution information.

5. The terminal as claimed in claim 4, wherein, when the requested user created content coincides with the display size information according to the resolution of the terminal, the content resolution information generation unit transmits the user created content and the resolution information of the user created content to the Java platform.

6. The terminal as claimed in claim 3, wherein, when the user created content is selected, the terminal platform transmits a file ID of the selected user created content and display size information of the terminal to the memory.

7. The terminal as claimed in claim 6, wherein the memory determines whether the user created content having the received file ID exists, when the user created content having the received file ID exists, determines whether the resolution information of the user created content coincides with the display size information of the terminal, and when the resolution information of the user created content coincides with the display size information of the terminal, transmits the user created content and the resolution information to the Java platform.

8. The terminal as claimed in claim 6, wherein, when the user created content having the received file ID does not exist, the memory transmits an error message to the terminal platform.

9. The terminal as claimed in claim 6, wherein, when the resolution information of the user created content does not coincide with the display size information of the terminal, selecting one of the at least one resolution modes that can be displayed on the display as the content resolution information, and transmits the selected content resolution information and the user created content to the Java platform.

10. A method for using user created content as a user interface in a terminal, comprising the steps of:
receiving a request for any of at least one pre-stored user created content from a terminal;
comparing the resolution information of the received user created content with a display size information according to a resolution of the terminal's display, the display including at least one resolution modes which a number of color image pixels arranged in vertical and horizontal directions on the display;
selecting one of the at least one resolution modes that can be displayed on the display as a content resolution information according to result of the comparing;
converting the resolution of the user created content using the received content resolution information;
storing the converted user created content using the received content resolution information in the memory; and
displaying the user created content with the converted resolution.

11. The method as claimed in claim 10, the step of storing the converted user created content using the received resolution information in the memory, the memory is a SIM card which externally connected to the terminal.

12. The method as claimed in claim 10, further comprising when the display size information of the terminal coincides with the resolution information, transmitting the resolution information that coincides with the user created content to the terminal.

13. The method as claimed in claim 10, further comprising, when the content resolution information that coincides with the display size information does not exists, transmitting an error message to the terminal.

14. The method as claimed in claim 10, wherein the step of comparing the display size information of the terminal coincides with the resolution information of the requested user created content, comprises:
receiving a file ID of the user created content and the display size information of the terminal from the terminal;
determining whether the user created content having the same file ID exists; and
when the same user created content exists, whether the resolution information of the user created content coincides with the display size information of the terminal.

15. The method as claimed in claim 14, further comprising, when the user created content having the same file ID does not exist, transmitting an error message to the terminal.

16. A method for using user created content as a user interface through a terminal to which a SIM card is externally connected, comprising the steps of:
requesting user created content from the SIM card installed in the terminal;
receiving the requested user created content and resolution information corresponding to the requested user created content from the SIM card, and copying and storing the received user created content and the resolution information; and
reconstructing the received user created content by converting the size of the user created content into a size corresponding to resolution of the terminal, and executing the reconstructed user created content.
